(19) United States
(12) Patent Application Publication
(10) Pub. No.: US 2020/0126594 A1
(43) Pub. Date: Apr. 23, 2020

(54) DOWNLOADING VIDEOS WITH COMMERCIALS TO MOBILE DEVICES

(71) Applicant: Penthera Partners, Inc., New York, NY (US)

(72) Inventors: Adam L. Berger, Pittsburgh, PA (US); Joshua Pressnell, Dayton, OH (US); Richard David Jackson, Parana (BR)

(21) Appl. No.: 16/724,780

(22) Filed: Dec. 23, 2019

Related U.S. Application Data
(63) Continuation of application No. 14/524,673, filed on Oct. 27, 2014, now abandoned.
Application No. 14/524,673 is a continuation of application No. 14/275,710, filed on May 12, 2014, now abandoned.

(51) Int. Cl. G11B 27/19; H04N 21/235; H04N 21/442; H04N 21/262; H04N 21/845; H04N 21/4335; H04N 21/81; H04N 21/432; H04N 21/44; H04N 21/84; H04N 21/414

(52) U.S. Cl. CPC G11B 27/19; H04N 21/2358; H04N 21/44204; H04N 21/26291; H04N 21/8458; H04N 21/8456; H04N 21/41407; H04N 21/4335; H04N 21/812; H04N 21/26258; H04N 21/4325; H04N 21/44016; H04N 21/84; H04N 21/44209

(57) ABSTRACT

Among other things, a video is downloaded to a mobile device. The video includes a TV show and commercials embedded within the TV show. The video is stored persistently on the mobile device. At least part of the video is played on the mobile device while the device is offline. Metadata is stored on the mobile device that indicates an expiry applicable to at least one of the commercials embedded in the video. The mobile device performs an action at a time related to the expiry.

This application is a continuation application and claims priority under 35 U.S.C. § 120 to U.S. application Ser. No. 14/524,673, filed Oct. 27, 2014 which is continuation of U.S. application Ser. No. 14/275,710, filed May 12, 2014, the entire contents of which are incorporated here by reference.

This application also cross-references the following patent applications and patent, each of which is incorporated by reference here in its entirety: Ser. No. 13/923,103, filed on Jun. 20, 2013; Ser. No. 14/016,963, filed on Sep. 3, 2013; U.S. Pat. No. 8,701,145, issued Apr. 15, 2014; Ser. No. 14/504,360 filed on Oct. 1, 2014; and Ser. No. 14/042,952, filed Oct. 1, 2013.

### BACKGROUND

This description relates to downloading videos with commercials to mobile devices.

### SUMMARY

In general, in an aspect, a video is downloaded to a mobile device. The video includes a TV show and commercials embedded within the TV show. The video is stored persistently on the mobile device. At least part of the video is played on the mobile device while the device is offline. Metadata is stored on the mobile device that indicates an expiry of the downloaded video. The mobile device performs an action at a time related to the expiry.

Implementations may include one or any two or more of the following features. The action includes refraining from playing out the downloaded video. The action includes deleting the downloaded video. The action is performed at a time when the mobile device is offline. The video includes one or more playlist files and one or more segments, and the playlist files and the segments are stored persistently on the mobile device. The expiry of the video is expressed as a date. The expiry of the video is expressed as an amount of time following an earlier fixed date and time. The mobile device downloads fewer than all of the segments. The mobile device can play the downloaded segments while the device is offline. The mobile device downloads multiple segments concurrently. At least part of the downloading occurs only when the mobile device is connected to a WiFi network and when the mobile device is being powered by an external source or has at least a certain battery charge or both. Another version of the video is downloaded to the mobile device. The other version contains the same TV show and at least one embedded commercial that is different from the commercials embedded in the original version of the video. The other version of the video has an expiry later than the expiry of the original version of the video. The other version of the video is downloaded, concurrently with the first version. The other version is downloaded after the downloading of the first version. The mobile device indicates to a remote server that the second video should contain longer-lived commercials.

In general, in an aspect, a first version of a video is downloaded to a mobile device. The first version of the video includes a TV show and commercials embedded within the TV show. The first version of the video is stored persistently on the mobile device. At least part of the video is played on the mobile device while the mobile device is offline. Metadata that indicates an expiry for the first version of the video is stored on the mobile device. Before, during, or after downloading the first version of the video, the mobile device downloads a second version of the video. The second version of the video contains the same TV show and at least one embedded commercial that is different from any of the commercials embedded in the first version of the video. The second version of the video has an expiry that is later than the expiry of the first version of the video. An app on the mobile device performs an action at a time related to the expiry of the first version of the video.

Implementations may include one or any two or more of the following features. The action includes playing the second version of the video. At least some of the commercials of the first version of the video have higher value than at least some of the commercials of the second version of the video.

In general, in an aspect, one or more commercials are downloaded to a mobile device. The commercials are stored persistently on the mobile device. One or more of the downloaded commercials are stitched into a previously-downloaded video that includes embedded commercials at least one of which has expired. The stitching is done at places in the downloaded video that are identified based on metadata downloaded separately from the downloading of the video. The video and the stitched in commercials are played while the device is offline.

Implementations may include one or any two or more of the following features. At the mobile device, for at least one of the commercials, a number of times the commercial is played is recorded. The recorded number is reported to a server when the device is not offline. The mobile device limits a number of times a stored commercial is stitched into the previously-downloaded video. The previously-downloaded video is segmented. The stitching includes replacing entries in the manifest for the video, the entries corresponding to the original commercials. The replacement commercials are segmented. The replacement commercials are not segmented.

Other aspects, features, and implementations and combinations of them can be expressed as methods, apparatus, systems, components, methods of doing business, program programs, means and steps for performing functions, and in other ways.

Other aspects, features, and implementations will become apparent from the following description and from the claims.

### DESCRIPTION

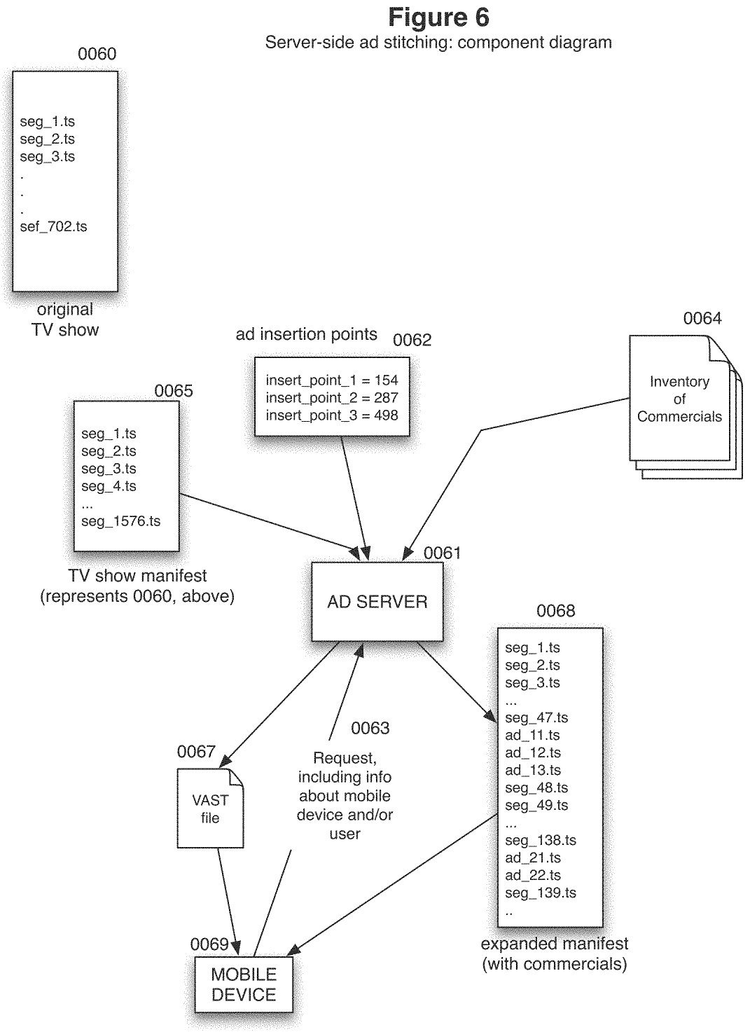

FIGS. 6, 9, 17, are block diagrams.

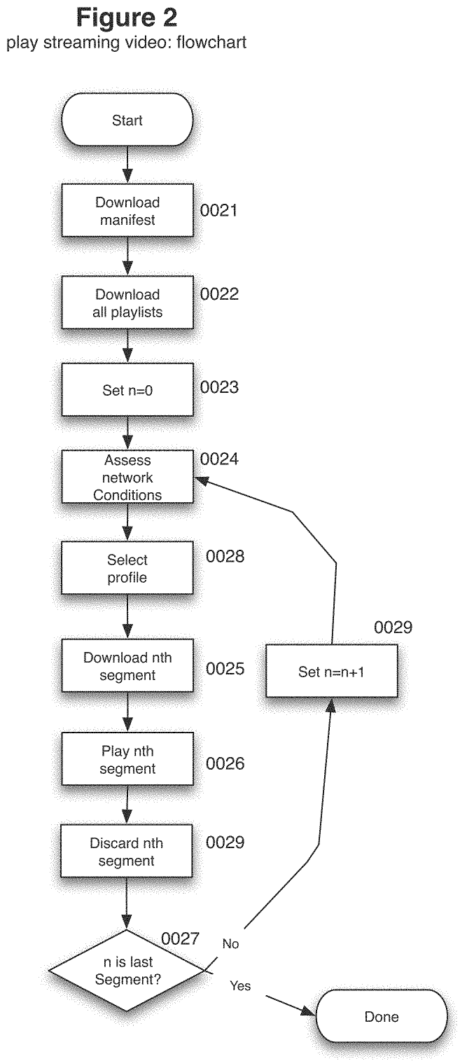

FIGS. 2, 8, 11, 12, 13, 15, 18, 20, 22, 23, are flow charts.

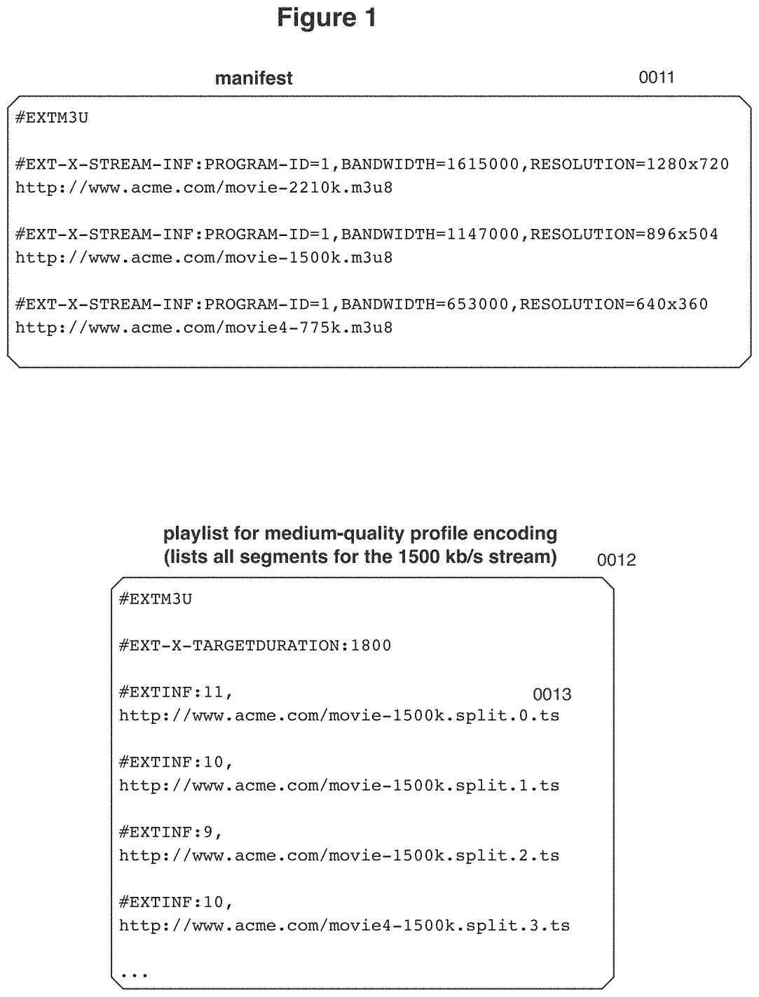

FIGS. 1, 3, 5, 10, 14, 16, 19, 21, 24, 25, are schematic diagrams.

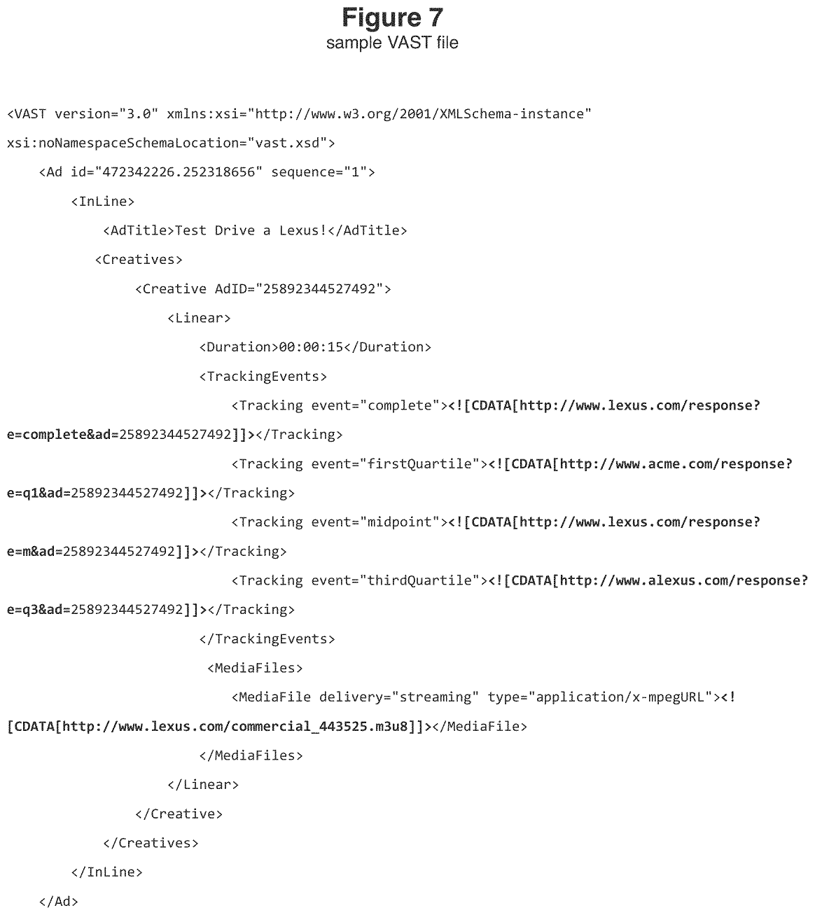

FIG. 7 is a code listing.

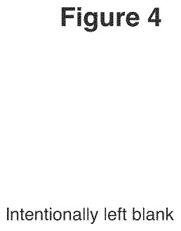

FIG. 4 is intentionally blank.

The system and techniques that we describe here support downloading to mobile devices of TV shows (and other forms of video) that include commercials.

In some implementations, a video is downloaded from a server to a mobile device where it is stored in persistent memory. The downloaded video includes a TV show and one or more commercials embedded before, within, or after the TV show, or any combination of those places.

The mobile device plays the downloaded video at a time after the video has been downloaded and stored. In some cases, the mobile device plays the downloaded video while the device is offline or has limited connectivity. In some examples, the mobile device plays the downloaded video when only part of the video has been downloaded.

In the following description, we use the term “app” or “application” or “mobile app” broadly to include, for example, any program that runs on a mobile device. An app may be, for instance, an executable binary that is installed on the device. An “app” may also refer to multiple executable binaries that work in conjunction with one another on a mobile device to perform one or more functions, for example, an Android service and an Android application that communicate with one another can be thought of as an “app.” An app may also refer to a script that is executed by another program, e.g. a javascript or Adobe Flash script that runs within a web browser. To simplify our presentation, we sometimes say the mobile device performs an action, although in fact the action is performed by an app running on the mobile device.

We use the term “offline” to mean that the mobile device has no network connection to the Internet through any communication channel, including cellular, WiFi, and Bluetooth. By “limited connectivity” we mean that the device has a network connection to the Internet, but using that network connection may be undesirable or inconvenient because the network connection has poor throughput or high latency or is expensive to use; for instance, a connection provided through a cellular network for which the user may have a limited monthly quota of data or have to pay per megabyte consumed. By “online” we mean the opposite of “offline”; that is, the device has a network connection to the Internet through some communication channel. A device with limited connectivity is by definition online; but a device that is online may have better connectivity than “limited”.

We use the term “system” broadly to include, for example, any set of components or facilities—mobile app, streaming video server, video download server, ad server, content delivery network, and possibly other elements, for example—that together comprise or provide or support a service that delivers video to devices and plays them for users of the devices.

We use the term “streaming” broadly to include, for example, a service that allows a user to view a video on a device as the video is being transmitted, in pieces, to the device over the Internet. During streaming, the recipient device typically does not store the entire video; instead, the device deletes each downloaded piece of the video at some time shortly after the device has played that piece of the video.

We use the term “mobile device” broadly to include, for example, any portable device, such as a cellular-enabled phone, a tablet, an in-car entertainment system, or a laptop, that is capable of receiving a video stream over a wireless network and playing the video stream as it is received, or storing a downloaded video item in a persistent memory of the mobile device and playing out the downloaded video item from the persistent memory, for example, at a later time.

We use the term “playing” broadly to include, for example, presenting a video, including, for example, an advertisement, on a mobile device for viewing by the user. We sometimes use the terms “playback” or “playout” interchangeably with “playing.”

We use the term “wireless networks” broadly to include, for example, 3G, 4G, LTE, 802.11 (also known as “WiFi”), Bluetooth, and other similar protocols for wireless data delivery, and combinations of them.

We use the term “streaming video server” broadly to include, for example, any server accessible to the mobile device over a network connection and capable of delivering video, for example, in conformity with Microsoft Smooth, Apple HLS, or other standard IP-based video-streaming protocols.

We use the term “recommendation engine” broadly to include, for example, a system that uses historical data to identify items of potential interest to a user.

We use the term “analytics server” broadly to include, for example, any server accessible to the mobile device over a network connection and capable of one or more of the following functions: receiving one or more files from a mobile device containing or reporting on past activity on the device, persisting this information, aggregating this information with similar information received from other devices, and generating a graphical or tabular representation of this collected information, or combinations of any two or more of them.

We use the term “TV show” broadly to include, for example, a video on a television broadcast network, a cable network, a web site, or an online video service like YouTube or Netflix. A TV show may be, for example, a drama, reality show, cartoon, sitcom, episode of a web series, feature-length movie, or user-generated video taken from the camera on a smartphone or tablet.

We use the term “commercial” broadly to include, for example, a video or audio element whose purpose is to advertise a product or service, and which appears in association with content, for example, before, during, or after a TV show. A commercial may be paid for and produced by an entity separate from the entity that produced the TV show. We use the terms ad, advertisement, and commercial interchangeably.

### Streaming Video

Streaming video to a mobile device has become a mature and popular technology. Pay-TV distributors, TV networks, and various Internet-based services each offer services that stream video over IP networks to mobile devices.

Video streaming over IP can be performed in unicast mode (i.e., one source delivering video over the Internet to one recipient device), commonly using the HTTP protocol (http://www.w3.org/Protocols/rfc2616/rfc2616.html). In some cases, video streaming over IP can be performed in broadcast or multicast mode (i.e., one source transmitting video over the Internet to multiple recipient devices), commonly using the UDP protocol (http://www.ietf.org/rfc/rfc768.txt).

There exist several popular video-encoding and delivery protocols (e.g., HLS, HSS, HDS, CFF) specifically designed for streaming video (see, for example, http://www.iis.net/downloads/microsoft/smooth-streaming and https://developer.apple.com/librarv/ios/documentation/networkinqinternet/conceptual/streaming mediaguide/Introduction/Introduction.html).

A video encoded in a streaming format video typically consists of many short video files, each containing a small piece of the full video. For example, a 30-minute video may consist of 1800 files, each representing two seconds of the original video. We refer to these individual pieces as “segments.” A segment may be, for instance, an MPEG-2 Transport Stream carrying H.264 video and AAC, MP3, or AC-3 audio.

Typically, for each available video, a streaming video server makes available for download a lookup table, often called a playlist, containing a list of pointers to a sequence of segments comprising the video. FIG. 1 (bottom) shows a small excerpt 0012 of a playlist for a 1,800-segment video encoded at 1500 kb/s. The playlist 0012 in FIG. 1 is written in the HLS format, but the playlist for a different streaming format such as HSS or HDS or CFF is similar.

Typically, a streaming video server makes each video available in multiple quality levels, of varying bitrates. For example, a video may be available at 775 kb/s (low quality), 1.55 Mb/s (medium quality), and 2.2 Mb/s (high quality). The quality of the appearance of a video to a user when the video is presented depends, for example, on how high the bitrate of the video is. We sometimes refer to a quality level as a “profile.”

Counting all the segments comprising a single profile, and all the multiple profiles, a single one-hour segmented video may contain many segments. For instance, an 1800-segment video in three different profiles contains 54000 total segments: 1,800 segments in the low profile, 1,800 segments in the medium profile, and 1,800 segments in the high profile.

Along with the three playlists corresponding to these profiles, a streaming server also publishes a lookup table, often called a manifest, containing a URL for each of these playlists, that is, an Internet address for the location where the playlist appears. FIG. 1 shows a manifest 0011 that lists the URL for each of three playlists for a movie encoded at 775 kbs, 1500 kb/s, and 2210 kb/s.

When a mobile device plays out a video by streaming, the device can elect to access any of the available profiles. Which profile the device selects will depend on various conditions, including, for instance, an assessment of the network throughput and the resolution of the device's display. To play a streaming video, a mobile device follows a sequence such as that in FIG. 2. The device first 0021 downloads the manifest for the video, and then downloads all playlists 0022 in the manifest. The device then assesses the current network conditions 0023 and determines the best profile 0024 to use, depending on these network conditions. The device begins and continues to download 0025 and play 0026 successive segments up to and including the final segment of the video. The device regularly reassesses 0023 network conditions and may switch profiles at any time according to its current assessment. Since switching between profiles can only occur between segments, if each segment is two seconds in duration (for example), the switching between profiles may not occur more frequently than every two seconds.

Since a receiving device may automatically and repeatedly switch among available profiles based on current network conditions, video streaming in this way is often called “adaptive streaming” or “adaptive bitrate streaming.”

Many variations of this flow are possible. For example, the device may assess network conditions 0023 less often than after each segment. The device may skip the downloading of one or more of the playlists 0022 until later, when the device decides to start playing segments from a particular profile that is not been previously downloaded. The user may request to start from somewhere other than the beginning of the video, in which case the initial segment value 0023 will be greater than zero. The user may skip forward or back in the video during playout, which will cause the segment number to change in a way other than incrementing by one 0029.

For simplicity, in the rest of this presentation, where the meaning is clear, we will typically use the term “manifest” to denote both the manifest and the individual playlist files corresponding to a single video.

Compared to delivering (e.g., downloading) a single, monolithic video file over the Internet, there are several advantages to using a segmented video format for streaming video. For one, the mobile device can automatically adjust the video quality during playout, based on current effective bandwidth. If the network conditions improve, the device can switch to the segments belonging to a higher bitrate profile (i.e. higher quality), and vice versa. A user will automatically experience a higher-quality video when her network conditions improve, without having to perform an explicit action to select a higher video quality. An example scenario is when there are two people both streaming high-quality video over a shared Internet connection, and then one person stops streaming video; the quality of the other person's received video may automatically improve because of the suddenly-improved network conditions.

Another advantage of a segmented video format is that it can simplify the insertion of commercials into a video. Inserting a commercial into a TV show that is a single file (e.g. mp4 format) can be technically difficult, involving splicing the commercials into the original video file. In contrast, inserting a commercial into a segmented video may be as simple as inserting new entries (corresponding to the segments that represent the commercials) into a manifest file.

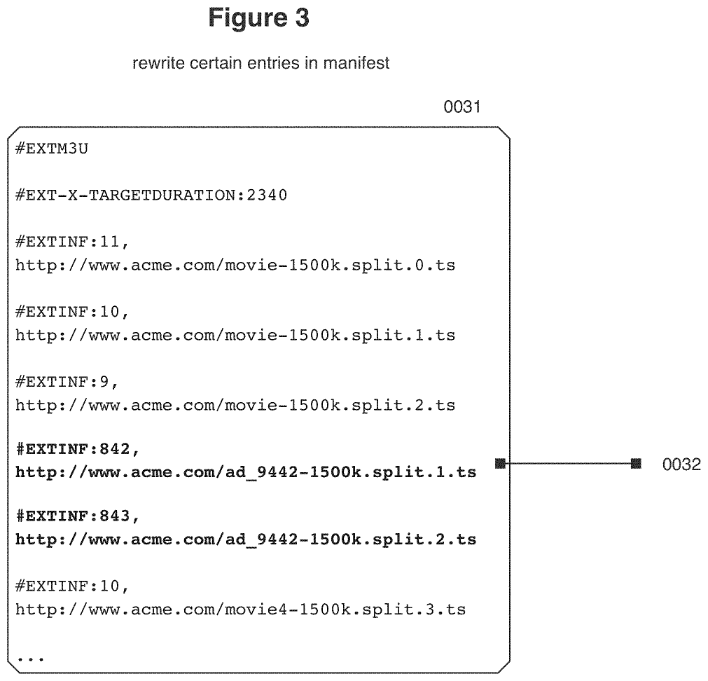

For example, FIG. 3 depicts the video manifest from FIG. 1, now with a commercial 0032 inserted after the third video segment. The inserted commercial in the figure consists of two segments, and is shown in bold in the manifest. Inserting a commercial into a segmented video is a relatively simple matter of inserting entries into the original manifest. Replacing a commercial in a segmented video is also relatively straightforward, by simply modifying the relevant entries in the manifest to contain the URLs of the segments of the replacement commercials.

From a mobile device, a user may play streaming video that has been encoded in one of the streaming protocols, using a web browser like Safari or Chrome running on the device. A user may also access streaming video using an application installed and running on the mobile device, such as Hulu Plus, Netflix, HBOGO, or SkyGo.

In many cases, the video segments are available through a content delivery network (CDN). A CDN is a large group of servers typically geographically widely dispersed, which deliver files through the Internet on behalf of customers who own that content and who pay a fee to the CDN to store and deliver the content to users quickly and reliably.

In some cases, the streamed videos may be “premium” content (e.g., HBO), access to which requires, for example, a monthly subscription fee. Such premium content typically includes few or no commercials. In other cases, the streamed videos may originate from ad-supported networks (e.g., ABC, AMC, Fox), in which case the videos may include, e.g., more than a few commercials.

A streaming video service may offer VOD (video-on-demand) or live TV, or both. By VOD, we mean, for example, a video service that offers a catalog of videos from which the user may select and view a video. Each of the videos in a VOD catalog was created at some time in the past; therefore, at the time when a video is being played, the entire video is already in existence. In contrast, a live TV service offers one or more video streams each of which is being created in real time during streaming. Therefore, at the time when a current portion of a live video stream is being played, later portions of the same video stream are being created. In that sense, a live TV video is incomplete during the time when it is being played.

An example of a VOD service is a movie-on-demand application, where a user can purchase the right to stream a video to her mobile device. An example of a live TV service is an application where one can watch a baseball game as it is being played.

### Online Video Advertising

The task of managing the selection and insertion of commercials into streaming video is well known. Companies including Brightcove, Adobe, Freewheel, and BlackArrow offer products and services that manage the selection and insertion (also known as “stitching”) of commercials into streaming video, and for measuring the viewing of each commercial.

We use the term “ad server” broadly to include, for example, any system that selects and delivers advertisements for placement into any kind of Internet-delivered content, such as TV shows, radio programs, web pages, or combinations of them; typically an ad server also then measures how these advertisements are viewed.

We use the term “measuring” broadly to include, for example, any tracking, observing, quantifying, recording, or generation of metrics that relates to display, performance, or presentation to a user and activities of the user associated with a commercial, for instance, recording whether a user triggers an interactive prompt displayed during the commercial (such as a pop-up that when clicked brings the user to a web page for more information), or whether a user exits the video application instead of watching the commercial.

The Internet Advertising Bureau (IAB), an industry consortium, has published a specification for the delivery and playout of ads within streaming video, called the Digital Video Ad Serving Template (VAST) (http://www.iab.net/vast).

A related specification, SCTE-130 (http://cablecongress.com/wp-content/uploads/cablecongress/2012/03/Daniel-Howard-SCTE-Day-3-Silver.pdf), defines various aspects of requesting, delivering, and selecting commercials for insertion into video content.

The ad server may produce (for delivery to a mobile device) a VAST file 0067 that specifies various information about commercials, including (1) the location of commercials in the video, and (2) actions that a receiving device should perform when playing the commercials. The VAST file may specify these commercial locations as millisecond time offsets from the beginning of the video, or as segments in the manifest that belong to commercials. The VAST file may also specify, for each embedded commercial, a set of zero, one, or more actions that the mobile device should perform when playout reaches a certain point in the commercial. An example of an action is a URL that the mobile device should “call”; these URLs are sometimes known as “tracking beacons” or “ad beacons” (http://www.iab.net/wiki/index.php/Web_beacon).

The purpose of a tracking beacon is to provide a record at a location other than the mobile device, that the mobile device has reached a point in the video where the commercial begins, ends, or is at some intermediate point. The data recorded by the tracking server may be provided to advertisers as verification that their commercials (or particular parts of them) have been played on a mobile device.

FIG. 7 shows an excerpt of a VAST file specifying URLs that the mobile device should request (or call or info) upon reaching (respectively) the end, first quarter, halfway point, and ¾-point of the commercial. The tracking beacons are specified in the section of the XML file underneath the <TrackingEvents> tag.

In many cases, an ad server includes several different functional components, including, for example, an ad-decision engine, and ad management service, and a content information system. These components work in concert to perform the functions of an ad server. For simplicity, we will refer to the aggregate system as an ad server.

Ad servers can insert a commercial before a TV show (typically called a “pre-roll”), in the middle of a TV show (an “interstitial”), and after the show (a “post-roll”), or any combination of two or more of these.

Ad servers typically support both linear and non-linear commercials. A linear commercial is a commercial that runs before, between, or after another video. In contrast, a non-linear ad runs next to some other video, e.g. presented to the viewer superimposed or next to the other video at the same time as the presentation of the video. To simplify the discussion, we will focus on linear ads, but the techniques and systems that we describe here apply to non-linear commercials as well.

### Ad Stitching

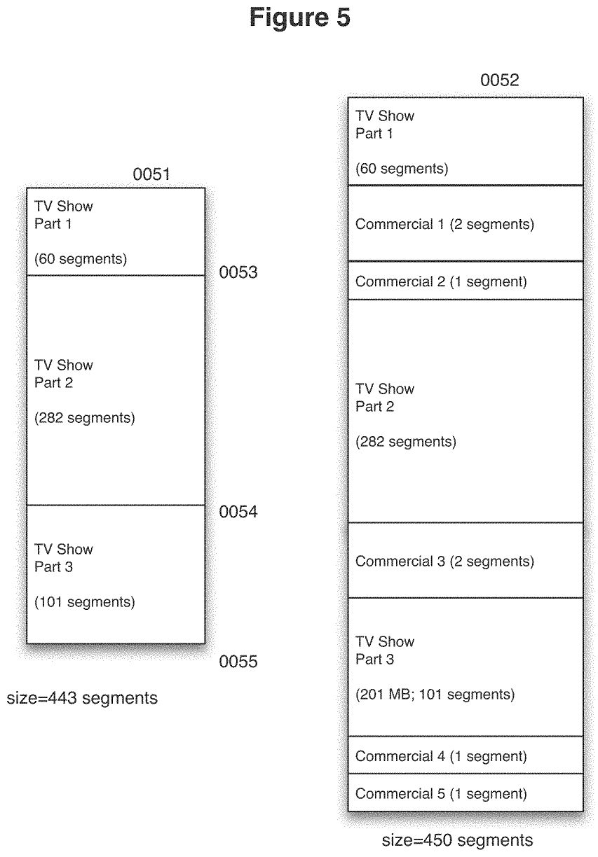

FIG. 5 depicts the result of ad-stitching. A TV show 0051 having 443 segments is shown as having three ad-insertion points. The ad server inserts two commercials at the first insertion point, one at the second insertion point, and two at the third insertion point. In this case, the resulting video 0052 with the stitched-in commercials is seven segments larger than the original TV show 0051 itself.

We distinguish between two main approaches to inserting commercials into online video: server-side and client-side.

### Server-Side Stitching:

Referring to FIG. 6, in some examples, an ad server 0061 selects from an inventory 0064 of commercials a subset of commercials to insert into a TV show 0060. In this example, the TV show 0060 has 702 total video segments and three ad-insertion points 0062, one after the 154th video segment, another after the 287th video segment, and a third after the 498th video segment.

In selecting commercials, the ad server may use information 0063 received from the device requesting the video. This information is often embedded in an HTTP request 0063 transmitted from the device to the ad server. This information may include, for example, the version and type of device and browser running on the device and the public-facing IP address of the device. The information may also include a unique identifier for the device, which allows an ad server to identify multiple requests from the same device occurring at different times. Different mobile operating systems implement unique device identifiers differently; one example is Apple's IDFA (https://developerapple.com/librarv/ios/documentation/AdSupport/Reference/ASIdentifierManager_Ref/ASIdentifierManager.html), which is available on iPhones and iPads with iOS6 and later versions. The ad server may use some or all of the information supplied by the mobile device 0069 to inform its selection of commercials.

In stitching the selected commercials into the video, the ad server relies on a table 0062 of insertion points associated with the TV show, indicating where commercials may be stitched into the TV show. We call this information “ad insertion points” or “avails.” The insertion points are typically identified by the party that provides the TV show originally.

We use the term “ad insertion points” broadly to include, for example, any indication of where (within a video) a commercial may be or must be inserted. An ad insertion point may be specified, for example, as a millisecond offset from the beginning of the TV show, e.g. 300,000 ms after the start of the video (i.e., exactly five minutes into the video). Alternatively, for streaming video, which is divided into many segments, an insertion point may be expressed as an index of a video segment after which a commercial may be inserted; e.g., “after the 192nd segment of the video.”

An ad server may insert zero, one, two, or more commercials at a single ad insertion point. In FIG. 5, for example, the ad server has produced an expanded manifest 0052 that includes two commercials inserted at the first ad insertion point 0053, one commercial inserted at the second ad insertion point 0054, and two inserted at the third 0055.

The ad server stitches the selected commercials into the TV show and delivers the resulting manifest 0068 over the Internet to a remote client device (e.g., a mobile device) for playout. A mobile device can download the manifest 0068 and play the associated video using the sequence depicted in FIG. 2.

An ad server may perform this stitching operation in response to and at the time when a mobile device requests the video, which means that each mobile device requesting the TV show from the server may receive the TV show with a different set of stitched-in commercials. One advantage of this “real-time stitching” is that the ad server can select commercials that are personalized to each user.

In some cases, the ad server may perform this ad-stitching operation just once for a TV show, and then deliver this expanded manifest to every mobile device that requests the TV show, so that every mobile device requesting the TV show from the server will receive the same set of stitched-in commercials. One advantage of this approach is a reduced computational load on the ad server, as compared with performing the stitching for every request.

Besides these two approaches, there are many in-between approaches, such as performing the ad-stitching operation once per day per TV show, and delivering that same result for all subsequent requests for that TV show until the next day.

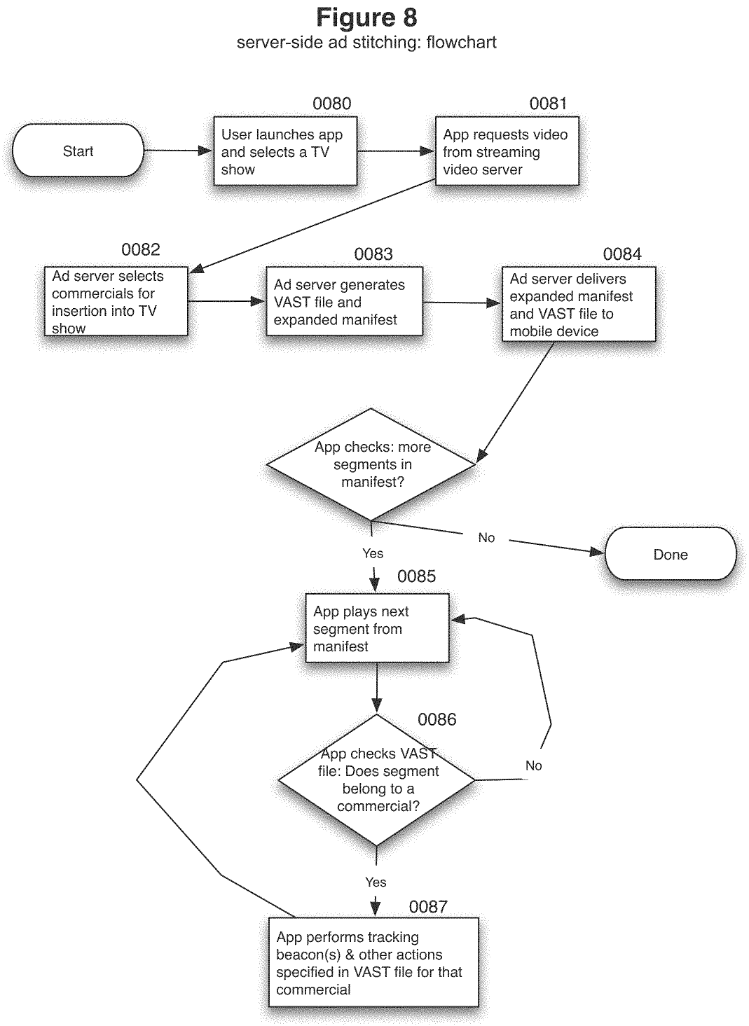

FIG. 8 outlines an example of the process of server-side ad stitching. One may think of FIG. 8 as a variant of FIG. 2 (streaming video playout) now accounting for insertion of commercials.
1. To begin, a user launches a video app on the device and, from within the app, selects a TV show to view 0080.
2. The app requests the video 0081, typically using an HTTP request issued to the streaming video server. The streaming video server alerts the ad server that the video is going to be streamed to the device.
3. The ad server selects 0082 a group of commercials to insert into this TV show.
4. The ad server builds a video manifest for delivery to the mobile device. The manifest will contain a list of URLs of segment files. Some of these segments correspond to the TV show, and some correspond to embedded commercials. This expanded manifest is also depicted 0068 in FIG. 6.
5. The streaming server delivers the manifest file to the device 0084.
6. The ad server delivers a VAST file to the device 0084 separately from the delivery of the manifest file by the streaming server to the device. The VAST file contains timing information specifying where are the embedded commercials in the video, and what action(s) the app should take when it encounters a commercial during playout. FIG. 7 depicts an example of a VAST file. Although in the client-side ad stitching scenario, a VAST file must contain a URL for each commercial, in server-side ad stitching the URL is not required, since the manifest delivered to the mobile device in the previous step already contains these URLs.
7. The app fetches and plays the video segments listed in the manifest 0085.
8. Eventually, the app reaches a commercial in the video 0086. If the app previously downloaded the VAST file from the ad server, then the app knows it has reached a commercial, because the VAST file contains a list of which segments in the video are commercials.
9. If the VAST file specifies an action during commercial playout, the app performs that action 0087. For example, the VAST file may specify a tracking beacon URL that the mobile device should connect to invoke when playout reaches the beginning of the commercial.

The actions illustrated in FIG. 8 need not take place in the exact sequence shown, some of the actions need not occur at all, and some actions not shown may be part of the sequence. For example, this sequence illustrates server-side ad-stitching with segmented video. Client-side ad-stitching (described below) implies a different sequence of operations, and flat video (instead of segmented video) also implies some differences in the process. Some ad servers may use a variant of the VAST protocol, or a different protocol altogether, to convey timing information about embedded commercials and actions to perform when playing commercials. For simplicity, FIG. 8 omits some of the details around video streaming, e.g., downloading the manifest and the individual playlists.

Client-Side Stitching:

In examples of client-side stitching, the ad server still selects the commercials, but it's the responsibility of the mobile device (not the ad server) to stitch the commercials into the TV show.

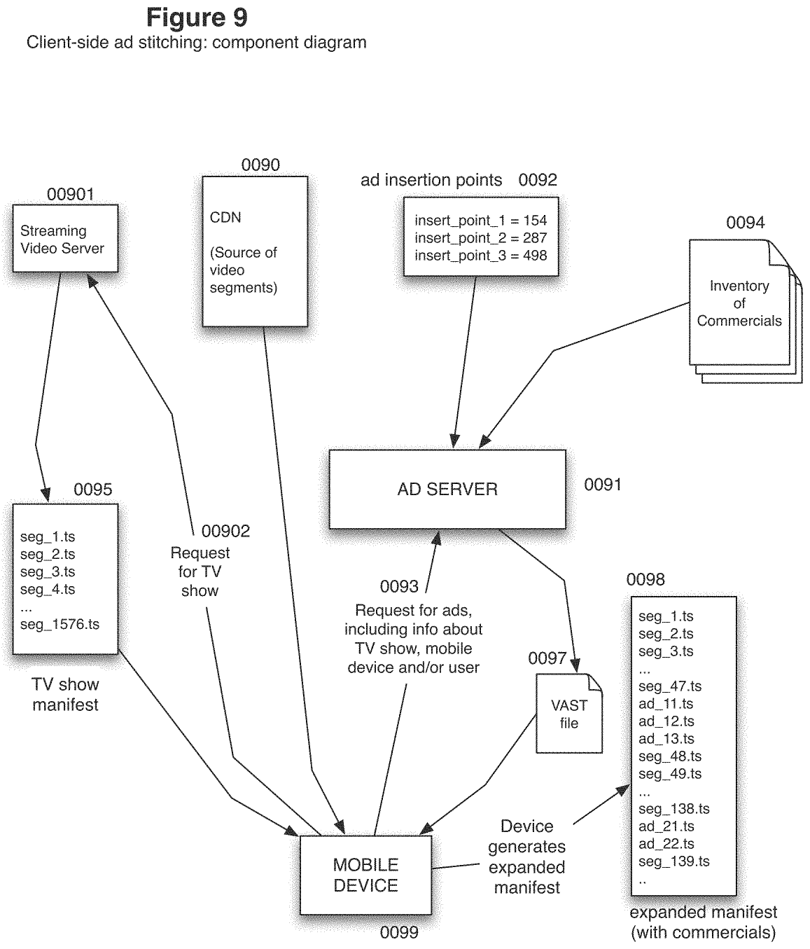

Referring to FIG. 9, a mobile device 0099 issues to a streaming video 00901 server a request 00902 to stream a TV show. In response, the device receives a manifest 0095 containing the segments for that TV show. Concurrently or shortly after receiving the manifest, the mobile device issues a separate request 0093 to the ad server 0091 for a set of commercials for the TV show. The request contains, among other things, an identifier for the TV show and certain information about the device and the user, as described earlier.

The ad server replies by downloading a VAST file 0097 to the device. The downloaded VAST file 0097 contains, for example:
1. Location of ad insertion points for the TV show.
2. URLs for the commercials that the mobile device should play at each of the insertion points. The commercials themselves may be encoded as flat files or as segmented video; therefore, each of these URLs may point to flat (e.g. mp4) files, or to a manifest corresponding to the commercial.
3. Action(s), for example one or more tracking beacons, that the mobile device should perform when it plays each commercial.

The mobile device then begins playing the TV show, starting from the first segment in the manifest file 0095. When the mobile device reaches the first insertion point according to the VAST file 0097, the mobile device 0099 fetches the first commercial (the URL for which is specified in the VAST file). The commercials may reside on the CDN 0090 that stores the segments for the TV shows, or the commercials may reside on a different server.

After playing the commercial, the mobile device 0099 resumes playing segments from the manifest 0095.

The reader will notice differences in the workflow for server-side and client-side ad stitching. In typical examples of server-side ad stitching, the video manifest contains segments belonging to both the TV show and to the embedded commercials. The mobile device plays segments from the video manifest, and doesn't need to perform any additional separate or explicit action to play out commercials, because the commercials are already “baked in” to the manifest received from the ad server.

In contrast, in typical client-side ad stitching, the manifest for the video doesn't contain commercials; it only contains segments belonging to the TV show. The mobile device consult the VAST file to determine when to interrupt playout of the TV show and play a commercial, and the mobile device also consults the VAST file to determine where (at what URL) to fetch the commercials.

Client-side and server-side stitching each have advantages and disadvantages. One liability of client-side stitching is that it requires additional software complexity on the mobile device to handle the fetching of commercials and stitching of the commercials into the TV show. On the other hand, this liability is also a benefit; performing this work on the mobile device reduces the burden of ad-stitching on the server.

Ad Selection:

In either client-side or server-side ad-stitching, the ad-selection process can be based on one or combinations of any two or more of the following factors, among others:
the kinds of video items (or specific videos or series) into which a commercial may be inserted: An advertiser may negotiate the right to insert its commercial into a certain set of video content and to exclude its commercial from other video content. For example, an advertiser may wish to display its commercial in sports-related videos, but not in reality shows. We will call the former the allowable videos for that advertiser. An ad server will only select a commercial if the video item is allowable for that commercial.
the number of overall impressions: Advertisers typically purchase a fixed number of impressions for a commercial. We use the term impressions broadly to include, for example, the number of times a commercial was inserted into the video and the user either watched the commercial to completion (allowed it to play through without exiting the app) or triggered an interactive element from the commercial or a combination of the two. The ad server may use the number of remaining (paid-for but unfulfilled) impressions for each commercial in its inventory as a selection criterion.
information about the user or device or both requesting the video: The ad server may employ in its selection criteria the location of the user (e.g., a GPS location or a coarser metric such as the city/state), the make and model of mobile device (e.g., Apple iPad 3), and, where available, other personally-identifiable information such as age and gender, and any combination of two or more of those.

### Video Expiry

In the context of video, we use the term “expire” to mean that the TV show is no longer allowed to be stored on the mobile device's persistent memory, or the TV show is no longer allowed to be played on the mobile device, or both.

For instance, many distributors of commercial video (e.g. Apple, Netflix, Dish, Hulu) provide to their customers the right to consume a video only for a limited period of time (often referred to as a “window”—see http://tidbits.com/article/9462). In some cases, a distributor may be contractually required to ensure that the video expires at the end of the negotiated window.

The video may expire for a number of reasons, including:
1. The TV show is outside its window.
2. One or more of the embedded commercials is no longer permitted to be stored on the device's persistent memory, or the commercial is no longer allowed to be played on the mobile device, or both.

A commercial may expire for a number of reasons. For example, AcmeCorp may purchase from a TV distributor 100,000 impressions of a commercial for an upcoming Memorial Day anvil sale). AcmeCorp realizes no value if the commercial is played after Memorial Day, and may contractually agree with the TV distributor to pay for “views” only until midnight of Memorial Day. After this time, it is in the TV distributor's economic interest not to play this commercial, but instead, to play other (non-expired) commercials. For another example, an advertiser may license a song from a musician for two weeks, after which time the advertiser no longer has the right to present the licensed song with the commercial. The ad server will only select commercials for insertion whose start time has passed but whose expiry has not yet occurred. In both scenarios, the commercial has a definite expiry date. We use the term expiry to refer to the time when a video or a commercial expires.

### Video Download

Recently, some companies have introduced video download as a new feature in their streaming products. Video download allows a user to download a video from a server to a mobile device for later viewing on the mobile device. Examples of download-enabled services are Comcast's Xfinity Go, Amazon Prime, and BSkyB's SkyGo Extra app. In some cases, a company may offer a download-only service, in which consumers may not stream, but only download TV shows, and then play these shows later.

We use the term “download” broadly to include, for example, any delivery of a video in its entirety from one or more servers to a mobile device, and the storing of that video on the persistent memory of the mobile device. In download, the recipient device stores the video persistently and can, for example, play out the video long after (e.g., minutes, days, weeks or longer) the video was delivered. The video may consist of one file, e.g., an mp4 file. In some cases, the video may consist of many individual files expressed in, e.g., a segmented video format such as HLS or HSS.

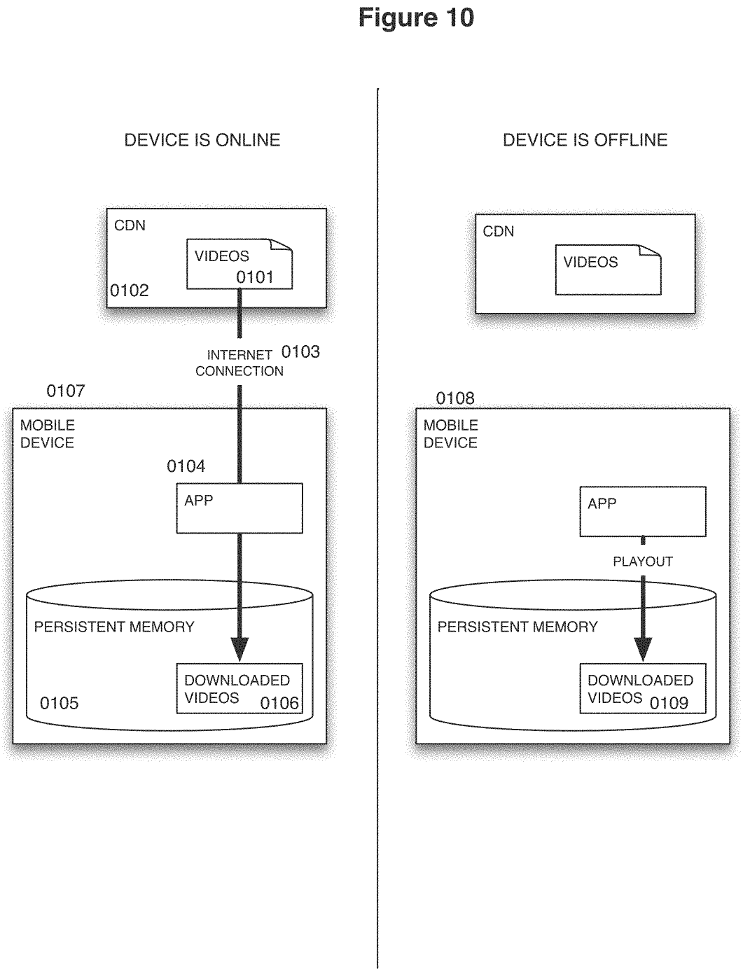

As shown in FIG. 10, for example, consider an app 0104 installed on a mobile device 0107. When the mobile device is online, as shown on the left side of the figure, the mobile device (e.g., through a feature of its operating system, an app, or a combination of an app and a feature of the operating system) supports downloading of videos 0101 from a server 0102 over an Internet connection 01013 to the persistent memory 0105 of the mobile device 0107. Each of the stored videos can be played back later, when the mobile device is offline, as shown on the right side of the figure, where there is no Internet connection between the mobile device and remote server.

The video item that is downloaded may be a VOD (video-on-demand) item, meaning that the video item is complete before it is made available for download. In some cases, the video item may be a live stream, meaning that the video item is being generated at the same time it is being downloaded. In some cases, the same video may be available first as a live stream and later as a VOD item. For instance, a university may make available over the Internet a lecture as the lecture is being presented, live; this video is a “live stream.” Later, the university may upload the complete video recording of the lecture to a web site for students to download; in this scenario, the video is a VOD item.

In some cases, the mobile device may initiate the download process by, for example, transmitting an HTTP ‘GET’ request (defined in http://www.w3.org/Protocols/rfc2616/rfc2616.html) to a remote web server that stores the object to be downloaded; the web server will in response deliver the video to the device using the HTTP protocol. In some cases, the mobile device may use a protocol, such as FTP (specified in http://www.w3.org/Protocols/rfc959), to fetch the video item from the remote source. In some cases, the server may signal the mobile device to initiate the download, for instance by sending to the mobile device a push notification message (https://developer.apple.com/notifications/ and http://developer.android.com/google/gcm/index.html), which causes the mobile device to launch an application or process to perform the download. In some cases, the mobile device may permit playout of a partially-downloaded video item.

We use the term “persistent memory” or “non-volatile memory” broadly to include, for example, any technology such as magnetic disk drive or solid-state memory that retains stored data, for example, even while a device is powered off. Storing a video in the device's persistent storage means that the stored video will remain on the device until the user or another application or the operating system itself deletes the video.

Among the advantages of a video-download feature are that a user can download a video from, for example, a VOD catalog when the device is online and the user is able to play the video later, when the device is offline. For example, a user can download a TV show or movie to her mobile device while she is at home, before leaving for the airport. Later, while she is in an airplane, she can play out the downloaded video, even though she has limited or no network connectivity in the airplane.

An advantage of a video-download feature is that users can consume high-quality videos from a VOD catalog even if the user only has access to a low-bandwidth network connection. For example, imagine the user wants to view on her mobile device a 10-minute video, which has been encoded in three formats: low quality (0.9 Mb/s), medium quality (1.7 Mb/s) and high-quality (3.8 Mb/s). Say the user has a 1.4 Mb/s network connection. Over this network connection, she can only stream the low-quality (0.9 Mb/s) version of the video. Attempting to stream the medium- or high-quality version of the video would fail, since the network connection cannot support the required data throughput; in other words, the network cannot “keep up” with the video. However, the user can download the high-quality version of the video, even over the 1.4 Mb/s network connection. Over this network connection, the download would require about 27 minutes. Once downloaded, the high-quality video is available at the mobile device for the user to play out. Thus, using download, a user can play out a high-quality video, even though the user does not have a network connection of high enough throughput to stream the video in high quality.

An advantage of a video-download feature is time-shifting from a time when a live TV show is being shown, for example, a rugby game scheduled for noon GMT, which is 4 AM Pacific Time, to a later time that is convenient for a rugby fan living in California. To do this, the fan can set his mobile device to record the show at 4 AM, and then the fan can watch the saved show at, e.g., 10 AM local time.

An advantage of a video-download feature is in reducing the use of expensive network connections. Typically, wireless operators like Verizon Wireless impose a monthly limit on cellular data usage, e.g., 2 GB per billing cycle, and impose an “overage” charge for data usage exceeding that limit in a given billing cycle. For instance, in early 2014, the network operator Verizon Wireless assesses a $15 overage fee per GB used above the subscriber's limit in any one billing cycle. A Verizon Wireless subscriber with a 2 GB quota can stream about 5.5 hours of 800 Kb/s video in a given billing cycle over the Verizon network, before overage charges apply. In other words, this Verizon Wireless subscriber is limited to about 5.5 hours of streaming video over the Verizon Wireless network until overage charges apply. A benefit of download is that Verizon Wireless subscribers who can plan ahead (and who have access to a download product) can download one or more videos in advance using a WiFi connection (e.g., at home or in their office), and subsequently watch these videos at a time and place where WiFi connectivity isn't available, thus avoid the risk of an expensive overage charge.

In other words, download enables wireless-mode shifting that reduces one's cellular data consumption without reducing one's overall video consumption.

A system that supports the downloading of videos to a mobile device may have some or all of the following features:
Using a mobile app or another tool (e.g., a web site, email, text messaging, or a TV set top box), the user may select a movie, an episode of a TV show, a live TV channel, or another video item and request that the video item be downloaded to the user's mobile device.
Using a mobile app or another tool (e.g., a web site, email, text messaging, or a TV set top box), the user may select an episodic program (e.g., a weekly TV series, podcast, or radio program) and request that some or all new episodes of the series be automatically downloaded to the device as they become available.
Using a mobile app or another tool (e.g., a web site, email, text messaging, or a TV set top box), the user may select an episodic program (e.g., a weekly TV series, podcast, or radio program) and request that some or all old episodes of the series be automatically downloaded to the device.
The user may delete downloaded video items, one at a time or several at a time, from the mobile device.
The system may delete certain video items automatically (e.g., older items, or items already viewed) to make room for new ones.
The mobile app may transmit information related to its past activity (e.g., which video items it downloaded and when) to an analytics server.
The system may employ a recommendation engine to identify videos that are of likely interest to the user, based on other videos the user has played and/or websites the user has visited, or other actions the users has taken. The recommendation engine may also rely on known behaviors of the user's friends (on social networks such as Facebook) to identify videos of likely interest. The system may automatically download these videos to the user's device.
The mobile device may query a remote server automatically, recurrently, for the existence of one or more new videos that the user has subscribed to, or that the recommendation engine has selected for delivery to the device. Instead of or in conjunction with such queries, a remote server may trigger the mobile device to initiate the download by transmitting a signal to the mobile device. Server-initiated signaling protocols include, for instance, APN (Apple Push Notification) for Apple mobile devices and GCM (Google Cloud Messaging) for Android devices.
The user may view the download status of currently-downloading videos and videos that are queued for download. The status may include, for example, the number of bytes downloaded and the number of bytes pending download, the percentage completed, the estimated time until download completion, and the number of videos to be downloaded in advance of a given video. We use the phrase “queued for downloading” to include, for example, scheduled to be downloaded to the mobile device but not yet completely downloaded to the device.
The system may download to the mobile device metadata along with the video item. Metadata may include, for example, a title, description, parental rating, closed-captioning, and an image corresponding to the video item. The metadata may also include one or more expiry dates for the item. One of these expiry dates may indicate a time after which the video item must not be played on the device. One of these expiry dates may indicate a time after which the video item must be deleted from the device. The metadata may come from a different server than the video itself, e.g., a content management server (CMS) such as those offered by Brightcove (www.brightcove.com) and thePlatform (www.thePlatform.com) The expiry may be expressed in absolute terms (“May 13, 2015 at 3:00 GMT”) or relative to some other time (e.g. “72 hours after the download is complete” or “24 hours after the downloaded show is first played on the device”). In some cases, the expiry may include multiple expiries, e.g., “The earliest of: May 12 at midnight AND 24 hours after the video is first played AND 168 hours after the video is completed downloading.” Even more complex descriptions of the expiry dates could be arranged. The mobile device stores this expiry constraint and can obey it in connection with the playback of the video. The mobile device may delete the video any time on or after its expiry date.
The system may enforce time windowing on the downloaded video item. We use the term “time windowing” broadly to include, for example, any controlling of the times or time periods during which a downloaded video item may or may not be played, e.g., a date after which (or before which or both) the video item is automatically made unplayable. At the time of forced expiry (the end of the time window), for example, the stored video item may be rendered unplayable or may be deleted from the device. Digital rights management (DRM) technologies, such as available from Adobe, Microsoft, SecureMedia, and Widevine, are one mechanism for enforcing the unplayability of a video based on the time windowing.
The system may perform downloading in the background. We use the term “in the background” to include, for example, any process that begins without requiring intervention by a user or that proceeds without notifying the user of the download's start, progress, or completion, or both. For example, a user can specify that she wants to download all new episodes of a TV show. The app can then download to the device all new episodes of the TV show, as the episodes become available. The user need not explicitly initiate or even be aware that a particular item is downloading. As another example, the app may automatically select video items that are likely to be of interest to the user (based, for instance, on other video items the user has recently viewed) and automatically download these items to the user's device; again in this case, the user need not explicitly initiate or request a specific video item to downloaded.
The user may receive an alert or “notification” by email, text message, or a visual or audible indicator on the mobile device, to indicate, for example, that the video has been successfully downloaded in full to the device and is now available for playout. (We sometimes use the word video interchangeably with the phrase video item.)
The system may perform downloading according to a set of rules that govern when downloading is permitted. For example, only when the device has more than 500 MB of free space, only when the device has more than 75% battery charge, or only when the device has a WiFi connection, or some combination of any two of these and other rules.
The system may download video items from a remote server on the public Internet, using standard protocols such as HTTP, TCP, and/or UDP.
The system may download video items from another device, such as a smartphone, tablet, PC, game console, or conventional digital video recorder (DVR). In each case, the source device (from which the video items are downloaded) may contain or have access to a magnetic disk drive, solid-state memory, or other persistent storage device where video items are stored.
The system may download video items from a network or “cloud” digital video recorder, a repository of video items stored on behalf of a user or household and available for delivery over the Internet to various IP-enabled devices. In some cases, downloading a video from a cloud DVR to a mobile device will trigger the deletion of the original version of the downloaded video from the DVR.
The downloading may occur through some combination of broadband networks, WiFi, and Bluetooth. In some cases, the downloading may occur through a cable that attaches the source device to the target device.
The system may allow the user to configure some or all aspects of the behavior listed above.

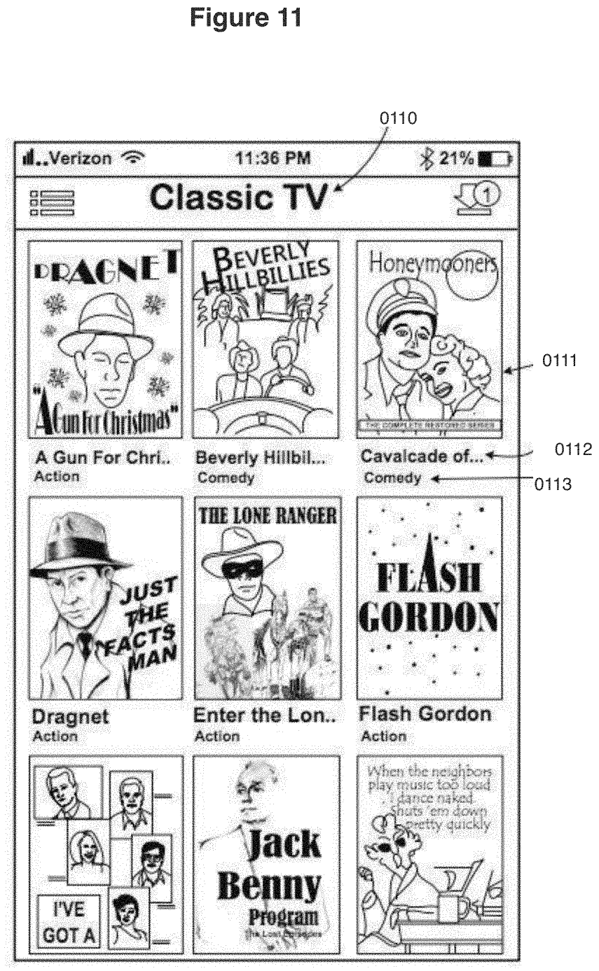

FIG. 11 illustrates a sample VOD menu for a mobile video download application. The app presents the user a list or gallery of videos that can be selected for downloading. The gallery may be grouped into broad categories 0110, such as Classic TV. Each of the listed items may be identified by the title's name 0112, cover art 0111, and genre 0113, among other things.

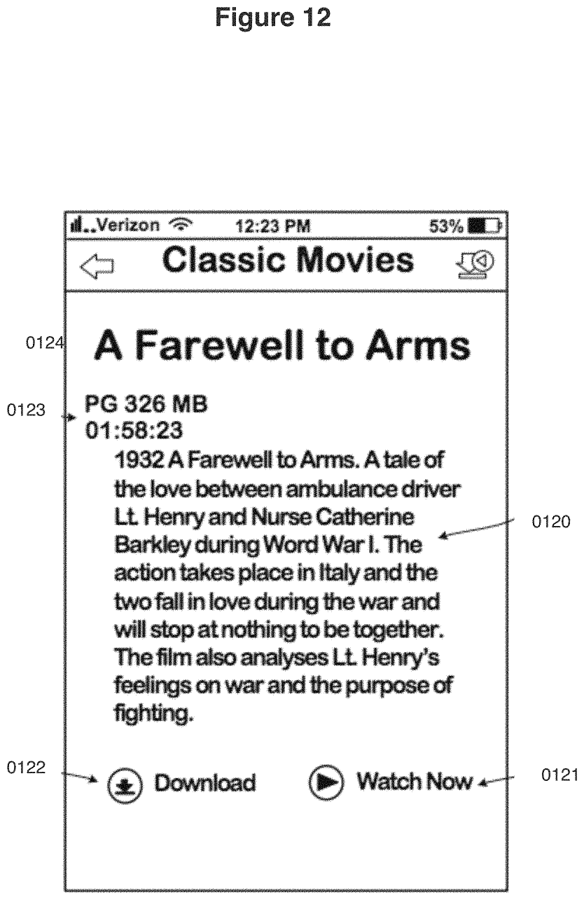

Selecting an item may bring up an additional screen, FIG. 12, with further description of the title 0124, runtime, and video size information 0123, and an option to stream the video now 0121 (“Watch Now”) or download the video for later viewing 0122.

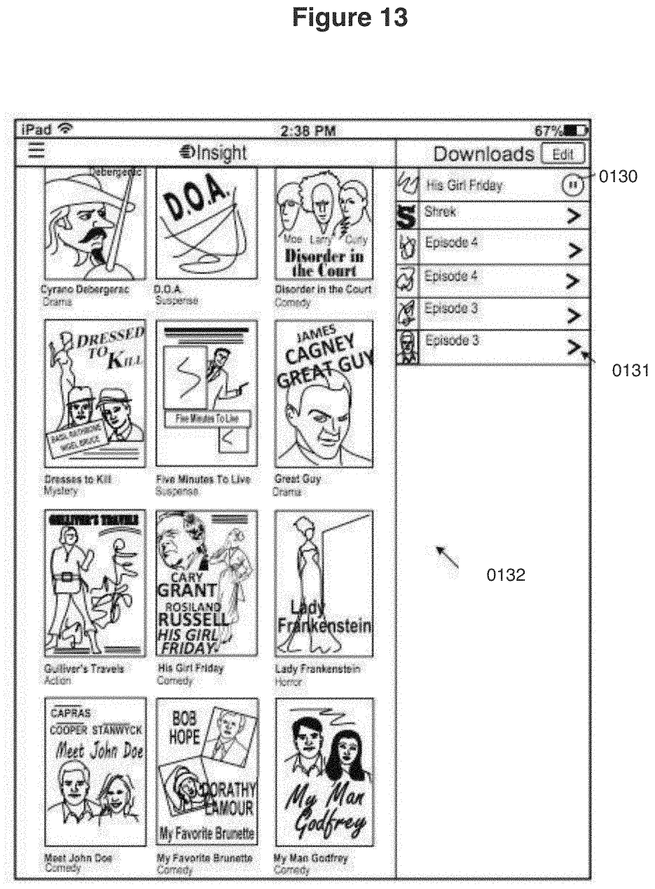

As shown in FIG. 13, the app can also present to the user a view of videos that have been downloaded 0131, or are in the process of being downloading 0130, or are queued for download or may present any combination of those. The videos being presented to the user can include videos that the user has explicitly requested to download, episodes of a series that the user has subscribed to, or videos that some other system element (for example, a recommendation engine) has elected to deliver to the device, for example. This view may be interactive: the user can see the progress of pending downloads, and play or delete any of the fully-downloaded videos. The user may be able to pause, resume, and cancel a single or two or more queued downloads, or all queued downloads, or perform some combination of the back of.

Downloading a Video in Streaming Format

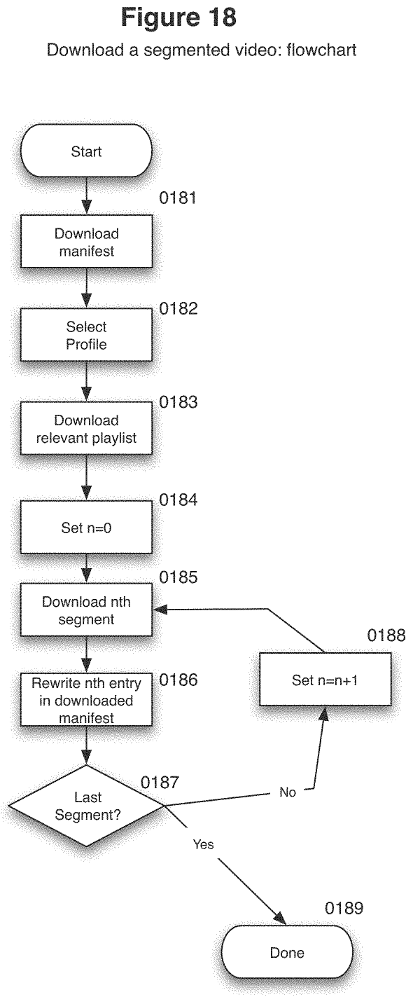

FIG. 18 shows an example of the process by which a video in streaming format is downloaded to a mobile device. Compare FIG. 18 (download a video) with FIG. 2 (stream a video). In streaming, the mobile device will typically discard 0029 a segment shortly after the device has downloaded and played that segment. In downloading, the mobile device does not play the segments as they are downloaded, but it also does not delete them; rather, the device stores all the downloaded segments in persistent memory for later playout.

There are other differences between FIGS. 2 (streaming) and 18 (downloading). In streaming, the mobile device checks the network conditions 0024 regularly, for example after every segment, and may switch to a different profile 0028, depending on network conditions. This “check and switch” is necessary because if the network conditions degrade to the point where the mobile device cannot download a segment in the time required to play a segment (e.g. two seconds), then video playout will eventually stall, waiting for the next segment to arrive. This problem typically doesn't occur when downloading, because the mobile device downloads all the constituent video fragments for later playout. In fact, switching between profiles in the downloading scenario may not be just unnecessary but undesirable, since a switch in profile during download means that during later playout, the user will experience a shift in video quality for no apparent reason. Therefore, in download, a mobile device typically selects one profile 0182 before beginning to download, and does not switch profiles during download.

For simplicity, we are not depicting in FIG. 18 the scenario where the mobile device resumes downloading a video that it had previously partially downloaded. In this case, the mobile device will “skip ahead” to the first not-yet-downloaded segment and begin downloading from that point. In this case, the step 0184 of setting n=0 would be replaced with setting n=k+1, where k is the index of the last downloaded segment.

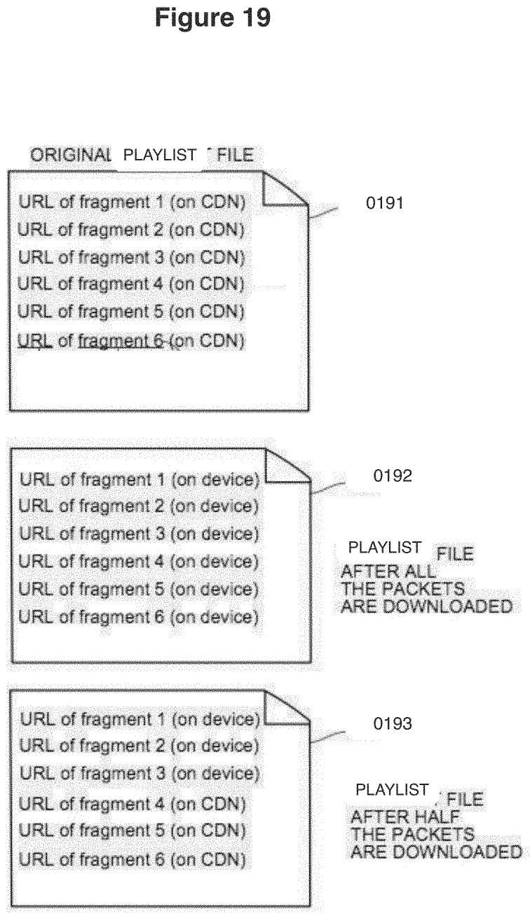

Notice in FIG. 18 that the mobile device downloads the selected playlist 0183 and then rewrites each entry in the playlist 0186 as the device downloads each segment in the video 0185. The purpose of this playlist-rewriting is so that the downloaded playlist is, at every point during the download process, a complete and usable lookup table for the fragments comprising the video. FIG. 19 illustrates this. Initially 0191 the manifest contains URLs referring to segments in their original location, on the remote server. A video player on the mobile device can refer to this manifest and (assuming the device has Internet connectivity) play the video using the process outlined in FIG. 2. After the mobile device downloads all the segments 0192, the playlist contains URLs referring to the downloaded, on-device copies of these segments. A video player on the mobile device can refer to this playlist and (even without Internet connectivity) play out the video, using the process outlined in FIG. 2. The bottom 0193 of FIG. 19 depicts a halfway stage, while the video is still being downloaded; in this case, half the segments refer to the downloaded segments and half refer to remote (not yet downloaded) segments. Even without Internet connectivity, the mobile device can use this playlist to play up to the point where the segments are no longer downloaded.

Optimizing Download Speed

We now describe an optimization that can result in much faster overall downloading of a segmented video.

The optimization is for the mobile device to download multiple segments concurrently, rather than one at a time. Downloading multiple segments in parallel can dramatically reduce the time required to download a video containing many segments.

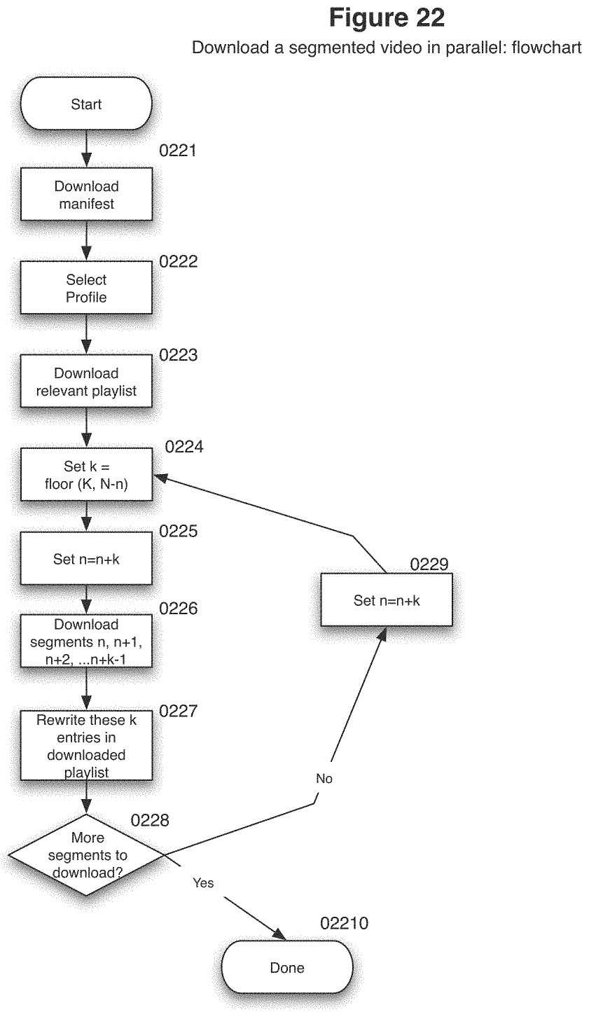

FIG. 22 shows a K-degree parallelization, i.e. the mobile device downloads up to K segments at the same time. This can lead to up to a K-time speedup in downloading of a single video. In some cases, K can be 10 or even higher, which can result in up to a 10× or higher download speed. The actual observed speedup depends on many factors, including the throughput of the network, the capability of the mobile device, and the size of the individual segments.

The mobile device may implement this parallel downloading using multiple downloading threads at a given time, each thread downloading a single segment.

There is no “one size fits all” value for K. Higher-performance mobile devices (e.g. those with multiple CPUs and more RAM) can support more concurrent download threads than relatively weaker-performance mobile devices. Thus it makes sense to use a large value of K for high-powered devices. But on a lower-performance mobile device, an app that attempts to initiate too many concurrent threads for downloading may experience undesirable effects, such as an application crash and/or poor overall responsiveness (http://stackoverflow.com/guestions/1285774/multi-threading-at-what-point-have-you-created-too-many-threads). Thus it makes sense to use a lower value of K for a lower-performance device.

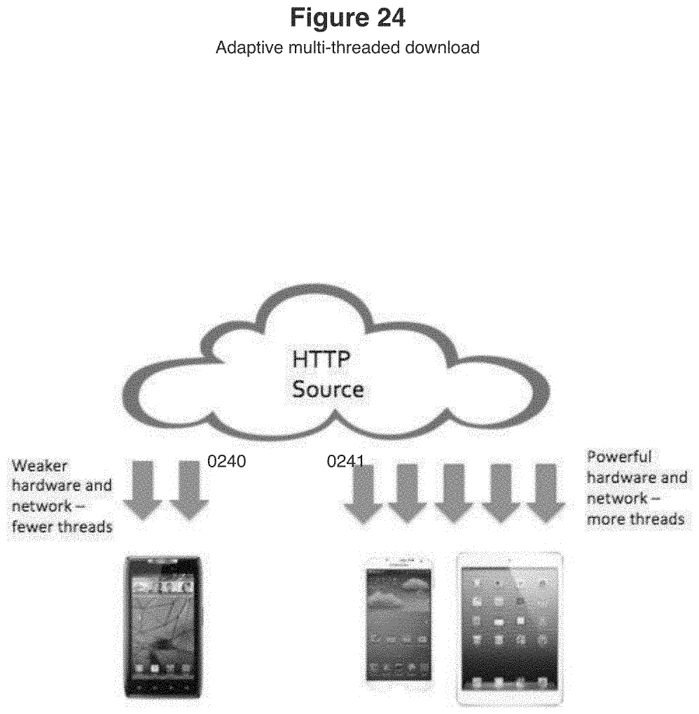

Thus an app may select a value of K depending on the mobile device's capabilities. FIG. 24 graphically depicts the situation where K may be either two threads 0240 or five threads 0241.

Foreground and Background Downloading

Some mobile operating systems, such as Apple's iOS, prevent apps from performing certain operations (e.g. downloading) when the app is not active.

By “active” we mean, for example, that what is displayed on the device's screen is generated by the app and not a different app or service on the device. Typically, a mobile device only has one active app at a time. A user can perform an action to select and switch among active apps (for example, as described in http://support.apple.com/kb/ht4211).

An app responsible for downloading a large video may find that the video is only partially downloaded when the app becomes not active.

It is desirable for the app to continue the download of the large video even when the app is not active, so that the next time the user engages with the app, the video that she previously requested to download is available in its entirety.

Some mobile operating systems offer a mechanism by which an app can request that the operating system download a file or set of files on behalf of the app, even if the app is not running. For example, the NSURLSession in iOS7 does this (https://developer.apple.com/library/ios/documentation/Foundation/Reference/NSURLSession_class/Introduction/Introduction.html#//apple_ref/occ/cl/NSURLSession). For shorthand, we'll refer to this as a “background download” mechanism, since it allows an app to cause a download of one or more files from a remote server to the mobile device, even when the app is in the background (not actively running).

It would be desirable to combine the fast, multi-threaded downloading available when the app is running with the reliable, albeit slower, downloading that is available using the operating system's background downloading mechanism.

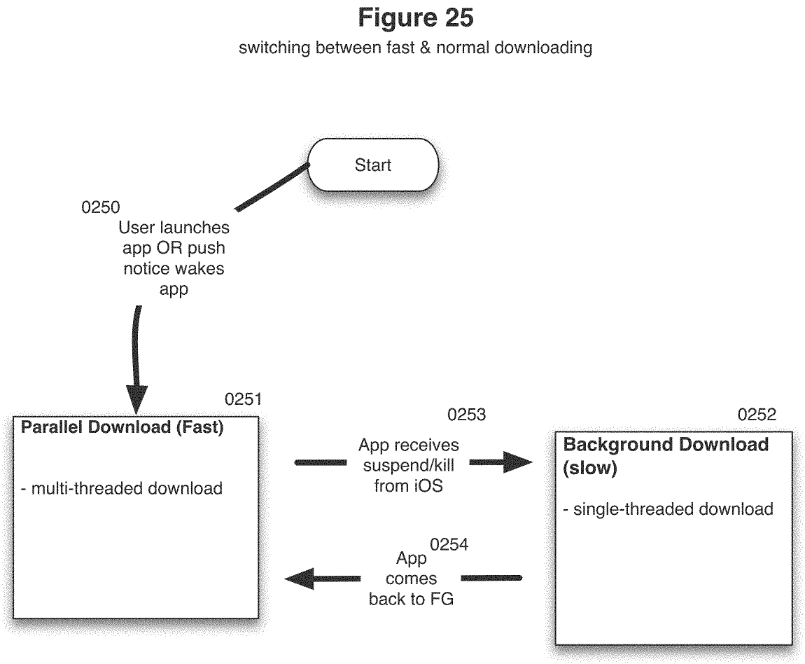

FIG. 25 depicts a “two-phase” downloading solution. The user initiates 0250 a download by selecting a video from within the app. Alternatively, the app receives from a remote server a push notification that “wakes up” the app and instructs the app to begin downloading a video.

The app initiates 0251 download of the video. As long as the app is actively running, the app controls the download itself, and performs a multi-threaded (fast) download. If the app stops actively running before the video is completely download, the app will (before it is suspended) hand off the in-progress download 0253 to the operating system's background-download process 0252. The hand-off ensures that the background download doesn't need to re-download any part of the video already downloaded.

If at any time during the background download process 0252, the app becomes active again 0254 (e.g., because the user launched the app again), then the parallel download process again takes over.

Not all operating systems require the two-stage process depicted in FIG. 25. Android, for instance, does not restrict the ability for an app or service to download while the app is not actively running; in that case, the app could continue the multi-threaded fast download even when the app is not actively running.

Downloading Videos with Commercials

Earlier, we described two processes:
1. From a mobile device, streaming and playing a TV show with commercials.
2. From a mobile device, downloading a TV show for later playout, for example when the device is offline.

There exist today many products that address each of these items separately.

Here we describe an intersection of these two processes. In some implementations of what we describe, a mobile device downloads a TV show with embedded commercials to a mobile device, stores the video on the persistent memory of the device, and plays the video later, for example, when the device is offline.

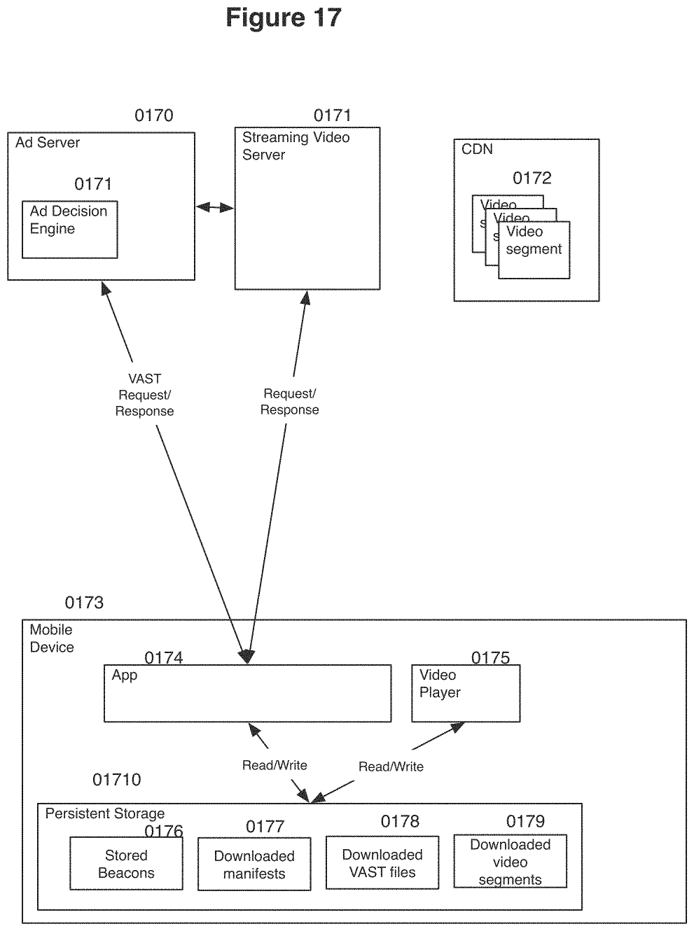

FIG. 17 shows the key components involved in downloading a TV show with commercials to a mobile device. An app 0174 on a mobile device 0173 contacts a streaming video server 0171 to request a TV show. The streaming video server contacts the ad server 0170 to request a group of commercials for insertion into the TV show. The video server delivers an expanded video manifest (including both the segments of the video and the segments of the Inserted commercials) to the app 0174, which downloads the manifest and then downloads each of the constituent segments and stores them 0179, as shown in FIG. 18 and FIG. 22. The app 0174 may rewrite the manifest as the video segments are downloaded, as described above (and illustrated in FIG. 19). Concurrently, the app 0174 also contacts the ad server 0170 to request a VAST file, which the app downloads and stores 0178 in the mobile device's persistent memory 01710.

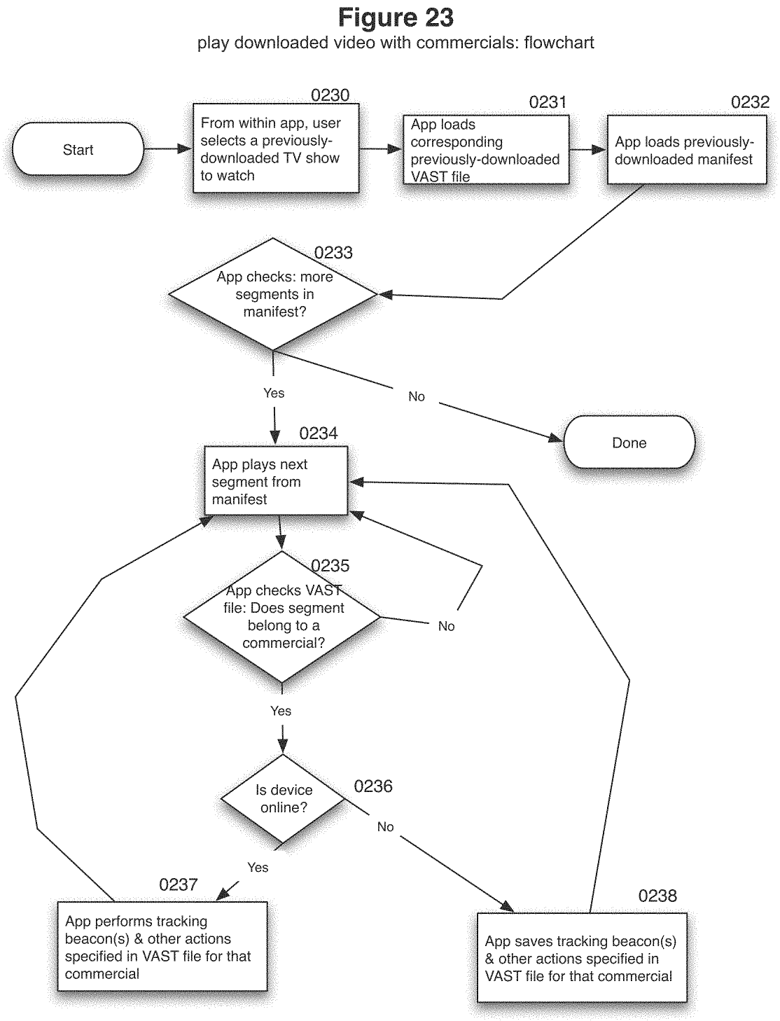

At some later time, perhaps when the device is offline, the user may request to play the previously-downloaded TV show. FIG. 23 illustrates the process. The user selects the TV show from within the app 0230. The app loads the corresponding (previously-downloaded) manifest 0231 and corresponding (previously-downloaded) VAST file 0232. Then the app begins playing the segments, one by one, by consulting the VAST file to determine the location in persistent memory for each segment and playing that segment 0234. If the segment belongs to a commercial (as specified in the VAST file), then the app will perform the action(s) specified in the VAST file 0237 as usual. But if the device is offline, the app cannot reach a remote URL corresponding to a tracking beacon. Therefore, the app will in that case save the beacon URL along with a timestamp denoting when the app played the segment 0238. At some later time (when the device is again online), the app will invoke the saved tracking beacon URL. This idea of ‘deferred tracking beacons is described more fully in U.S. Pat. No. 8,718,445, Incorporated here in its entirety by reference.

The “Stale Commercials” Problem

Here we discuss how to deal with the ‘stale commercials’ when: a downloaded video contains commercials that have expired.

As described here, stale commercials in a downloaded video can be avoided by downloading to the mobile device a second version of the TV show, with a different set of embedded commercials that expire later in time than the commercials in the first version.

Referring again to FIG. 6, the mobile device 0069 downloads the first video by contacting the ad server 0061 and supplying information 0063 about the device or the user of the device or both. The ad server 0061 will generate an expanded manifest 0068 for the video. The ad server transmits a VAST file 0067 to the mobile device 0069. Although we have referred here to FIG. 6 (which depicts segmented video files), an analogous flow occurs with flat video files.

At some time before, during, or after (or some combination of them) it has downloaded the first video, the mobile device 0069 downloads a second version of the video by contacting the ad server 0061. This request for a second version can include a directive to the ad server expressing a preference for long-lived commercials or at least an expired commercials. Once again, the ad server 0061 will generate an expanded manifest 0068 for the video. This time, the ad server 0061 will generate an expanded manifest 0068 that embeds “long-lived” commercials; i.e., commercials that do not expire soon (say within the next day or week or month), or otherwise unexpired commercials. For example, the ad server may select promotional commercials, public-service announcements, or ‘evergreen’ commercials that never expire.

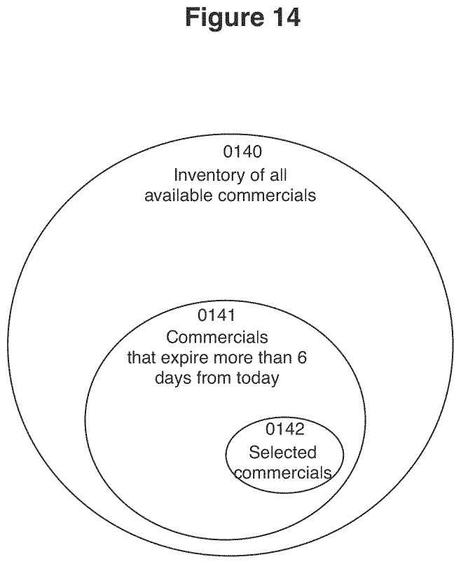

FIG. 14 depicts this ad-selection process graphically. The ad server has an inventory 0140 of commercials to select from. The ad server employs a decision engine to select, from among this inventory, which commercials are optimal. In general, as we have discussed earlier, the ad decision engine may select different commercials depending on various factors including the make/model of device requesting the TV show, the identity of commercials and videos previously delivered to the device or to the user, the expiry of each available commercial, and many other factors. Certain of the commercials 0141 available to insert are “long-lived” in that they do not expire soon (e.g., the next day, or week, or month). When the mobile device supplies a directive to the ad server to prefer long-lived commercials, the ad server will select a group 0142 of commercials from within this subset 0141 of “long-lived” commercials.

For example, the primary or first version of the video may contain commercials that have an expiry of three days, and the secondary or second version may contain a different set of commercials that have a later expiry.

At least one and as many as all of the stitched-in commercials of the second version of the video are different from the stitched-in commercials of the first version of the video. The second version of the TV show may have commercials embedded at the same or different places from the first version of the TV show. In some cases, the two versions may have a different number of commercials inserted at the same position in the TV show.

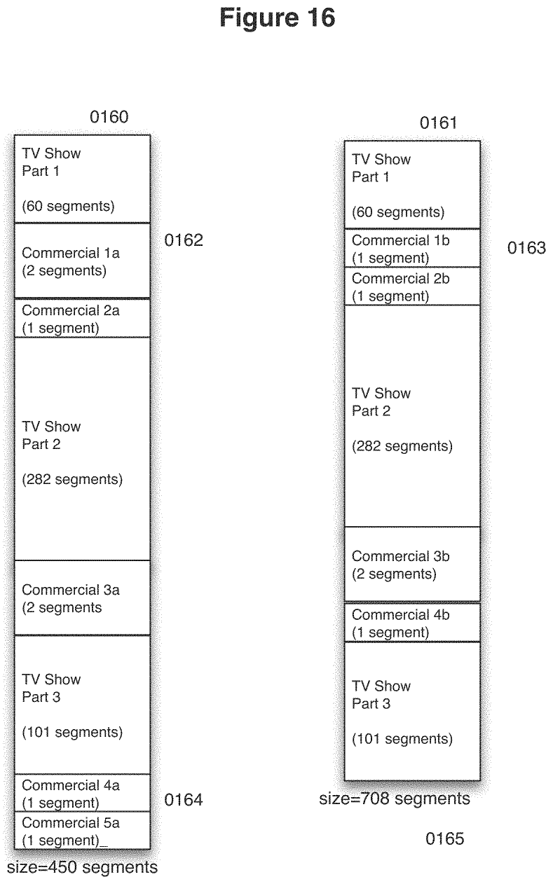

FIG. 16 depicts two versions 0160, 0161 of the same TV show, having respectively different embedded commercials. Notice that some ad-insertion points 0162, 0163 have different numbers of inserted commercials in the two videos, and in some cases, there are commercials at an ad-insertion point in one version of the video 0164 but not in the other version of the video 0165.

The second version of the video has an expiry that is later that the expiry of the first version.

The mobile device may download this second version at different times relative to the downloading of the first version of the video, e.g.:
At the same time as it downloads the first version; in other words, the two videos are enqueued for download simultaneously.
When the first version of the video has already been downloaded, and time has elapsed; and the expiry of the first version of the video is now less than 24 hours in the future, for example.
when the first version of the video has already been downloaded, and time has elapsed; and the expiry of the first version of the video is in the past.

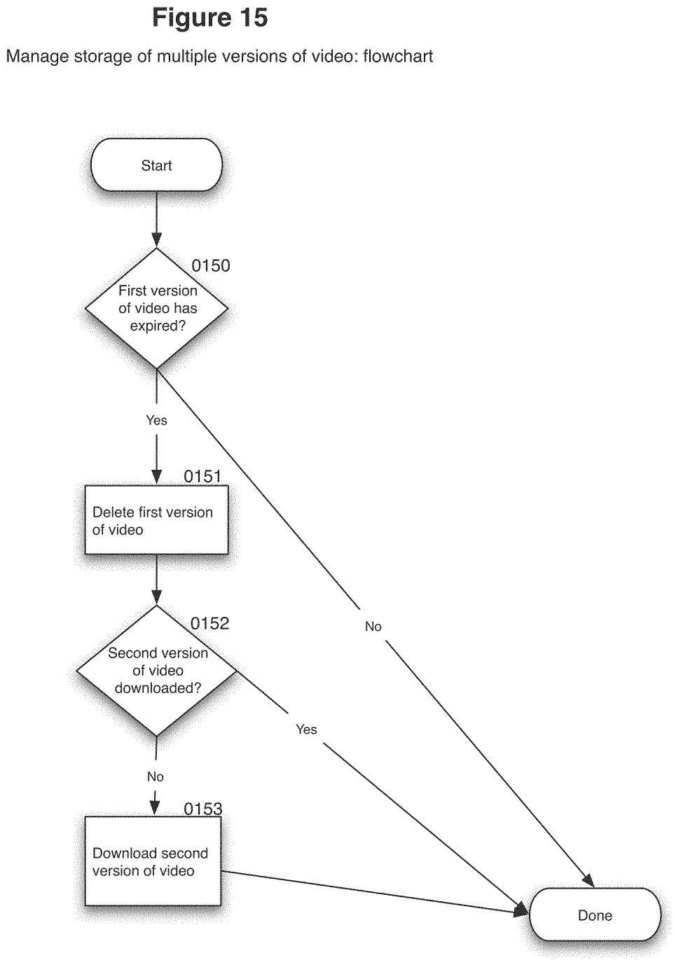

The mobile device may regularly monitor its downloaded versions of videos to see which have expired. Monitoring may occur automatically at regular intervals (e.g. every hour, every day, every week). Or, monitoring may occur only when the user performs a specific action, such as launching or using a particular app. FIG. 15 depicts this process. To begin, the mobile device checks to see if the first version of the video (previously downloaded) has expired 0150. If so, the mobile device may optionally delete that version 0151, to reclaim storage space on the persistent storage of the mobile device. Then, the mobile device checks if the second version is downloaded 0152, and downloads it 0153 if not. Once the first version of the video has expired, the mobile device uses the second version of the video in place of the first version of the video.

Variations of this sequencing are possible, for example, the mobile device may download the second version of the video simultaneously with the first version, or may download the second version once the first version is less than a certain period of time (e.g. 24 hours) of expiring.

The first and second video may be in segmented format, or in a single-file format.

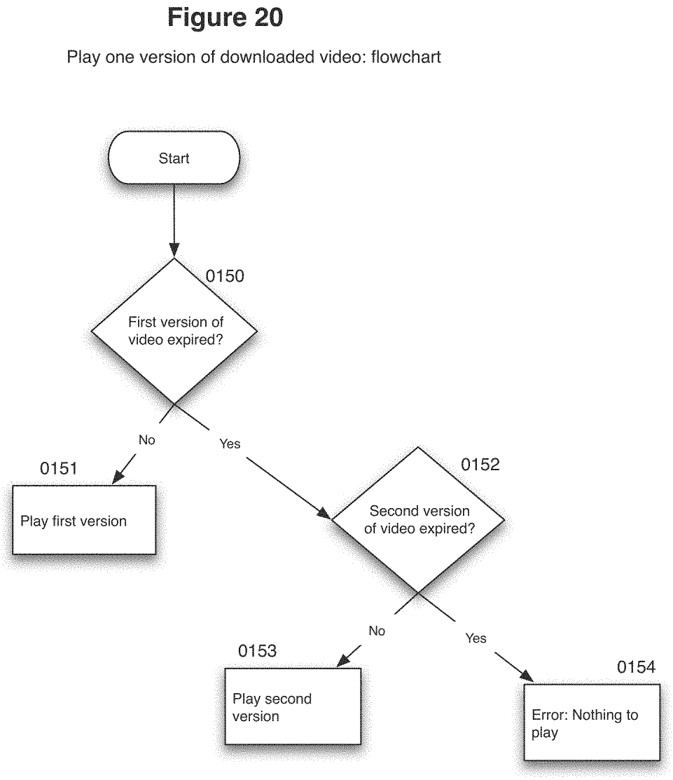

After the mobile device has downloaded the two versions of the video, FIG. 20 illustrates one possible sequence for deciding which version of a video to play. In some examples, the mobile device will opt to play the first version of the video 0151 unless it has expired, in which case the mobile device will play the second version 0153, unless it too has expired 0154.

We now describe a variant of the “two versions” approach just described.

Rather than downloading a complete second version of the video, the mobile device may download from the ad server just a set of replacement commercials, to be “spliced” into the original video in place of the original commercials.

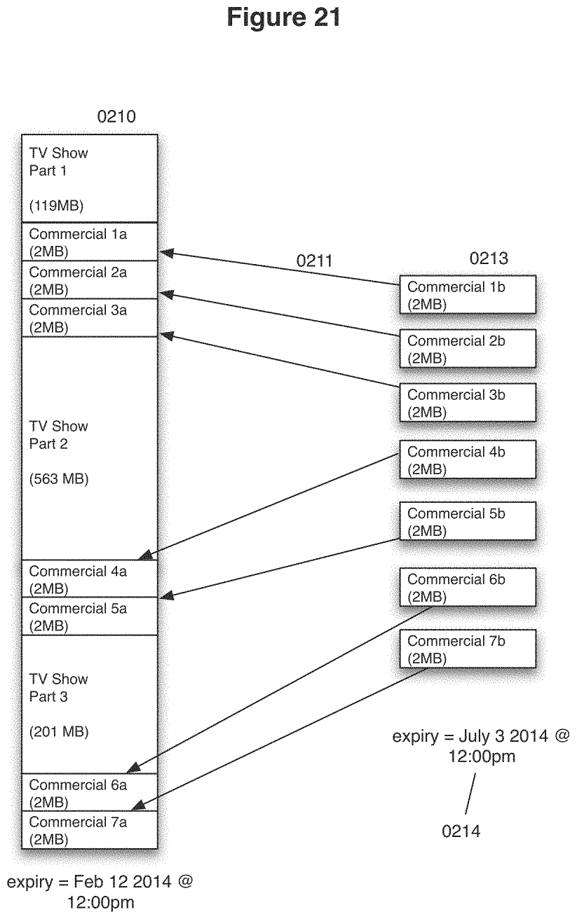

FIG. 21 depicts this process. On the left is the first video, with embedded commercials. On the right is a set of replacement commercials, with a later expiry. The mobile device contacts the ad server as in FIG. 6 to download the first video. The mobile device also contacts the ad server, supplying 0063 a request with a special directive that indicates to the ad server to supply just a set of manifests for the new commercials. The mobile device then downloads the new commercials. The mobile device follows the sequence in FIG. 20 to determine whether to play the first version of the video, or (if the first version has expired) to create a second version of the video. The mobile device creates the second version of the video by replacing the entries in the original manifest corresponding to the original commercials with the replacement commercials. For example, in FIG. 3, the mobile device will replace the two bold entries with new entries, corresponding to the backup commercials.

The techniques described herein can be implemented in digital electronic circuitry, or in hardware, firmware, software, or in combinations of them. The techniques can be implemented as a program product, i.e., a computer program tangibly embodied in an information carrier, e.g., in a machine-readable storage device or in a propagated signal, for execution by, or to control the operation of a processor, a computer, or multiple computers. A program can be written in any form of programming language, including compiled or interpreted languages, and it can be deployed in any form, including as a stand-alone program or as a module, component, subroutine, or other unit suitable for use in a computing or mobile environment. A program can be deployed to be executed on one computer or mobile device or on multiple computers or mobile devices at one site or distributed across multiple sites and interconnected by a communication network.

Activities that we describe can be performed by one or more programmable processors executing a program to perform functions by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the program and/or the processor/special circuitry that implements that functionality.

Processors suitable for the execution of a program include, by way of example, both general and special purpose microprocessors, and any one or more processors of any kind of digital computer or mobile device. Generally, a processor will receive instructions and data from a read-only memory or a random access memory or both. Generally, a computer or mobile device will also include, or be operatively coupled to receive data from or transfer data to, or both, one or more mass storage devices for storing data, e.g., magnetic, magneto-optical disks, or optical disks. Information carriers suitable for embodying program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques that we describe can be implemented on a computer or mobile device having a display device, e.g., a CRT (cathode ray tube) or LCD (liquid crystal display) monitor, for displaying information to the user and a keyboard and a pointing device, e.g., a mouse or a trackball, or a touch surface, by which the user can provide input to the computer or mobile device (e.g., interact with a user interface element, for example, by clicking a button on such a pointing device or touching the touch surface). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques that we describe can be implemented in a distributed system that includes a back-end component, e.g., as a data server, and/or a middleware component, e.g., an application server, and/or a front-end component, e.g., a client computer or mobile device having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, cellular telephone networks, and Wi-Fi, and include both wired and wireless networks.

The computing system can include clients and servers. A client and server are generally remote from each other and typically interact over a communication network. The relationship of client and server arises by virtue of programs running on the respective computers or mobile devices and having a client-server relationship to each other.

Other implementations are within the scope of the following claims.

1. A method comprising
based on entries in a first manifest, downloading to a mobile device segments of a video that includes a TV show and at least one commercial embedded within the TV show, the embedded commercial having an expiry,
storing the downloaded segments as a first version of the video persistently on the mobile device,
at the mobile device receiving a second manifest of entries for segments of at least one other commercial,
storing the segments of the other commercial persistently on the mobile device,
forming an updated first manifest by replacing entries for the segments of the embedded commercial with entries for the other commercial from the second manifest, and
using the updated first manifest and the stored segments of the other commercial to play, while the mobile device is offline, at least part of a second version of the video including the second commercial in place of the embedded commercial, the embedded commercial having reached its expiry.

2. The method of claim 1 in which the video comprises one or more playlist files, and the playlist files are stored persistently on the mobile device.

3. The method of claim 1 in which the expiry of the commercial is expressed as a date.

4. The method of claim 1 in which the expiry of the commercial is expressed as an amount of time following an earlier fixed date and time.

5. The method of claim 1 in which at least part of the downloading of the segments of the video occurs only when the mobile device is connected to a WiFi network and when the mobile device is being powered by an external source or has at least a certain battery charge or both.

6. The method of claim 1 in which the first version of the video has an expiry, and the method comprises
downloading another version of the video that includes the same TV show and at least one different commercial embedded within the TV show, the other version of the video having an expiry later than an expiry of the original version of the TV show, and
playing the other version of the video after the expiry of the original version of the video.

7. The method of claim 6 in which the segments of the other version of the video are downloaded concurrently with the first version.

8. The method of claim 6 in which the segments of the other version of the video i-s are downloaded after the downloading of the segments of first version.

9. The method of claim 6 in which the mobile device indicates to a remote server that the other version of the video should contain longer-lived commercials.

10. The method of claim 1 comprising, at the mobile device, recording, for at least one of the commercials, a number of times the commercial is played.

11. The method of claim 10 comprising reporting the recorded number to a server when the device is not offline.

12. The method of claim 1 comprising the mobile device limiting a number of times a stored commercial is stitched into the downloaded video.
